(19) United States
(12) Patent Application Publication
(10) Pub. No.: US 2014/0064530 A1
(43) Pub. Date: Mar. 6, 2014

(54) IMPLANTABLE MICROPHONE

(71) Applicant: Hannes Maier, Hamburg (CH)

(72) Inventor: Hannes Maier, Hamburg (CH)

(73) Assignee: ADVANCED BIONICS AG, Staefa (CH)

(21) Appl. No.: 14/004,901

(22) PCT Filed: Mar. 17, 2011
(86) PCT No.: PCT/EP11/54062

§ 371 Date: Nov. 22, 2013

(51) Int. Cl. H04R 25/00; H04R 1/04

(52) U.S. Cl. CPC H04R 25/65; H04R 1/04
USPC 381/322; 381/361

(57) ABSTRACT

An implantable microphone, comprising a source of incoherent light, a light detector for outputting a signal corresponding to the total light intensity impinging onto a detector surface, a housing for housing the light source and the detector, and a sensor membrane for being exposed to surrounding soft tissue, the membrane being arranged to seal an opening of the housing and comprising reflector means provided at the inner side of the sensor membrane for reflecting light from the light source onto the detector in manner that the total light intensity reflected onto the detector varies as a function of the position of the reflector means relative to the detector.

The invention relates to an implantable microphone, in particular for placement in soft tissue of a patient.

Fully implantable hearing aids require biocompatibility and the possibility to implant all components of the device, in particular also the microphone. Typically, microphones are based on electromagnetic, electrostatic or piezoelectric detection of the deflection of a membrane of the microphone. As an alternative concept, the membrane deflection may be detected optically.

US 2001/0042844 A1 and US 2001/0043378 A1 relate to optical microphones wherein the intensity of light emitted by a light-emitting diode (LED) and reflected at a vibrating membrane is detected by a photo detector in order to sense the distance to the membrane.

GB 2,335,108 relates to an optical microphone comprising a plurality of optical fibers for transmitting light to a vibrating membrane where the light is reflected into a bundle of optical fibers.

U.S. Pat. No. 7,711,130 B2 relates to an array of optical hearing aid microphones supplied with light from a laser diode via a common multi-mode fiber.

US 2007/0161848 A1 relates to an implantable microphone employing an interferometer principle for detecting the vibration of a membrane.

The article “Direct measurement of intra-cochlear pressure waves” by E. S. Olson, Nature, Vol. 402, 2 Dec. 1999 relates to an optical principle for measuring pressure waves within the cochlea.

WO 2007/001989 A2 relates to a microphone which is to be implanted in soft tissue at a location spaced from the surface of the patient's skull.

Interferometer measurements of deflections are precise but restricted to sub-micron ranges and prone to non-linearities as well as to high position sensitivity, which results in a significant temperature sensitivity of the interferometer measurements. Also, interferometer measurements require a relatively complex optical setup including beam splitters.

It is an object of the invention to provide for an implantable microphone which provides for stable operation when implanted and which nevertheless has a relatively simple design. It is also an object of the invention to provide for a corresponding hearing assistance method using such microphone.

According to the invention, these objects are achieved by an implantable microphone as defined in claim 1 and a hearing assistance system as defined in claim 33, respectively.

The invention is beneficial in that, by reflecting incoherent light at the membrane onto the detector in a manner that the total light intensity reflected onto the detector surface varies as a function of the position of the reflector means relative to the detector, a relatively simple design can be achieved which also allows to achieve linear response characteristics. Also, the microphone is not sensitive to temperature-related length changes. The invention also allows for small size of the microphone. The measurement principle is based on a measurement of the relative displacement between the reflector means of the sensor membrane and a reference consisting of the housing with the light source and the optical detector.

Preferred embodiments of the invention are defined in the dependent claims.

Hereinafter, examples of the invention will be illustrated by reference to the attached drawings, wherein:

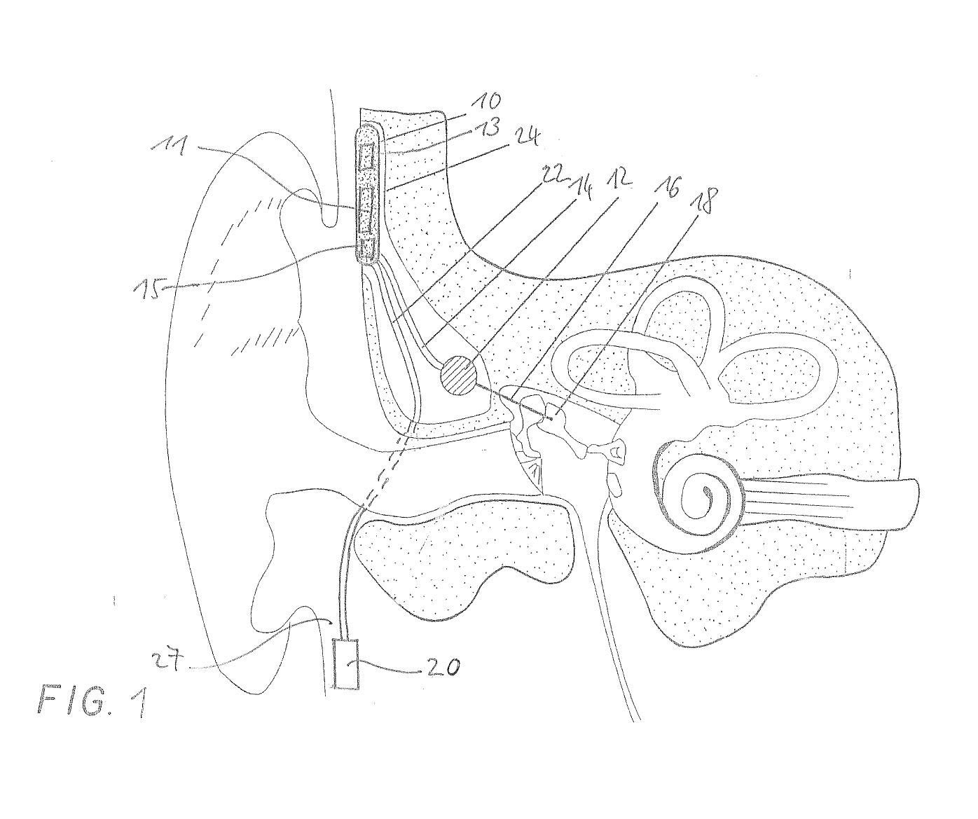

FIG. 1 is a cross-sectional view of an example of a hearing instrument using an implantable microphone according to the invention after implantation;

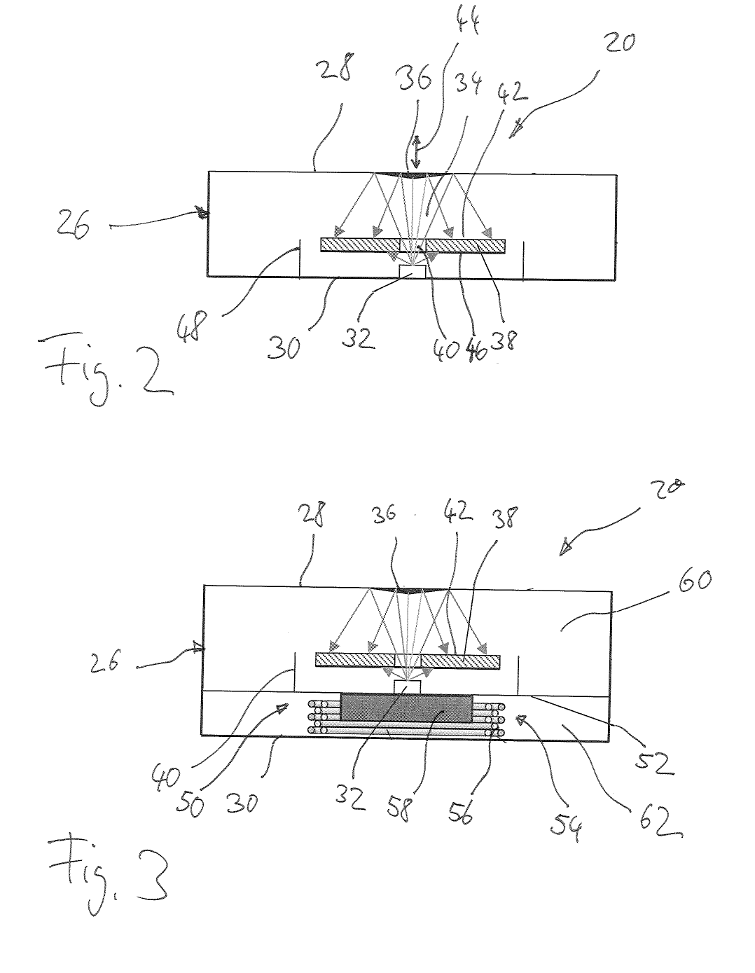

FIG. 2 is a schematic cross-sectional view of a first embodiment of an implantable microphone according to the invention; and

FIGS. 3 to 5 are views like FIG. 2, wherein alternative embodiments are shown.

In the example shown in FIG. 1, a fully implantable hearing aid comprises an implanted housing 10, an implanted output transducer 12 which is connected via an implanted line 14 to the housing 10 and which, in the example of FIG. 1 is designed as an electromechanical transducer for vibrating, via a mechanically coupling element 16, an ossicle 18, and an implanted microphone 20 connected via a line 22 to the housing 10.

The housing 10 is accommodated in an artificial cavity 24 created in the mastoid area and contains an audio signal processing unit 11, an electric power supply 13, a driver unit 15 and optionally components for wireless communication with a remote device. The power supply 13 typically includes an induction coil (not shown) for receiving electromagnetic power from a respective power transmission coil of an external charging device (not shown) and a rechargeable battery (not shown). Charging of the power supply 13 may be carried out during night when the user is sleeping.

The audio signal processing unit 11, which typically is realized by a digital signal processor, receives the audio signals captured by the microphone 20 and transforms them into processed audio signals by applying various filtering techniques known in the art. The processed audio signals are supplied to the driver unit 15 which drives the output transducer 12 accordingly, where they are transformed into a respective vibrational output of the transducer 12. Rather then being implemented as an electromechanical output transducer, the output transducer 12 could be any other known type of transducer, such as a floating mass transducer coupled to an ossicle, a cochlear electrode for electrical stimulation of the cochlear or an electrical or mechanical transducer acting directly on the cochlear, for example at the round window.

The microphone 20 preferably is placed in soft tissue 27 in a manner that it is completely surrounded by soft tissue, i.e. it neither touches a bone nor is it exposed to air.

A first embodiment of the microphone 20 is shown in FIG. 2, comprising a rigid housing 26 having an opening sealed by a sensor membrane 28 and a rigid wall 30 extending parallel and opposed to the membrane 28. A source 32 of incoherent light 34 is rigidly supported by the stiff wall 30 opposite to the sensor membrane 28. The light source 32 preferably is a superluminescent diode (SLED). The housing 26 may be made of titanium; also the membrane 28 may be made of titanium or any other biocompatible appropriate material. The interior of the microphone 20 is hermetically sealed by the housing 26 and the membrane 28. The membrane 28 is provided at its inner side with a reflector element 36 for reflecting light 34 emitted by the light source 32. The reflector element 36 preferably is located in a central region of the membrane 28 and may comprises at least one light-reflecting surface which is angled with regard to the membrane 28. Preferably, the reflector element 36 has a convex shape and is symmetric with regard to a central point. In particular, the reflector element 36 may have a cone-like, spherical, pyramid-like or truncated shape.

A light detector 38 is located between the light source 32 and the sensor membrane 28. The detector 38 preferably is a photo diode and has a central opening 40 which acts as an aperture for allowing light 34 from the light source 32 to pass through the opening 40 to the reflector element 36. The light-sensitive surface 42 of the detector 38 preferably is oriented essentially parallel to the sensor membrane 28. The detector 38 is supported by the stiff wall 30. The light 34 from the light source 32 is reflected at the reflector element 36 in such a manner that it impinges at an oblique angle onto the detector surface 42. As a consequence of such optical arrangement, the total intensity of the light reflected onto the detector surface 42 varies as a function of the axial position of the reflector element 36 relative to the detector surface 42.

For example, when the reflector element 36 moves upwardly with regard to the position shown in FIG. 2, the total amount of light reflected onto the detector surface 42 will decrease. Hence, the output signal of the detector 38 corresponding to the detected total light intensity is a measure of the distance between the reflector element 36 and the detector surface 42. Thereby the signal of the detector 38 is modulated according to vibrations of the membrane 28 in the direction of the arrow 44. The outer side of the membrane 28 is exposed to soft tissue surrounding the microphone 20, so that the membrane 28 is vibrated by sound waves travelling through the soft tissue surrounding the microphone 20.

The interior of the housing 26 and the back side 46 of the detector 38 are blackened in order to reduce stray light. The interior of the housing 26 may include structures 48 acting as additional collimators and/or absorbers in order to further reduce unwanted reflections.

It is to be understood that the reflector element 36, rather than being implemented as a separate element, may be realized as an inherent part of the membrane 28, namely by a reflecting part of the membrane surface.

In the embodiment of FIG. 2 the “reference” formed by the light source 32 and the detector 38 is fixed with regard to the housing 26. In FIGS. 3 to 5 alternative embodiments of the microphone 20 are shown, wherein the reference formed by the light source 32 and/or the detector 38 is elastically supported by the housing 26 in a manner that the light source 32 and/or the detector 38 is/are displaceable in a direction towards and away from the sensor membrane 28, i.e. in the vibration direction 44.

By using such suspension of the “reference”, acceleration effects on the microphone output signal due to acceleration of the tissue overlying the sensor membrane 28 may be reduced (such unwanted acceleration effects in the microphone signal interfere with the desired audio signals captured from sound waves travelling through the tissue), as will be explained in more detail below.

In the embodiment of FIG. 3 a support arrangement 50 is provided for elastically supporting the light source 32 and the detector 38 with regard to the housing 26. The support arrangement 50 as such is fixed at a rigid part of the housing 26.

Preferably, the support arrangement 50 is designed such that the damping and the spring constant of the support arrangement 50 are adjustable. In the example shown in FIG. 3, the support arrangement 50 comprises a reference membrane 52 fixed at and extending across the housing 26 parallel to the sensor membrane 28, with the reference membrane 52 serving to support both the light source 32 and the detector 38. The support arrangement 50 also comprises an active magnetic damping element 54 acting as a support for a central region of the reference membrane 52. The magnetic damping element 54 comprises a coil 56 fixed at the stiff wall 30 opposite to the sensor membrane 28 and a magnetic core 58 located in the coil 56 and supporting the central region of the reference membrane 52. A current may be applied to the coil 56 in order to adjust the spring constant and/or the damping of the support arrangement 50; in particular, a DC current may be applied to the coil 54 for adjusting the spring constant of the support arrangement 50.

The reference membrane 52 separates a first internal cavity 60 from a second internal cavity 62 of the housing 26, wherein the pressure within the first cavity 60 and the pressure within the second cavity 62 may be adjusted in order to adjust the spring constant of the support arrangement 50.

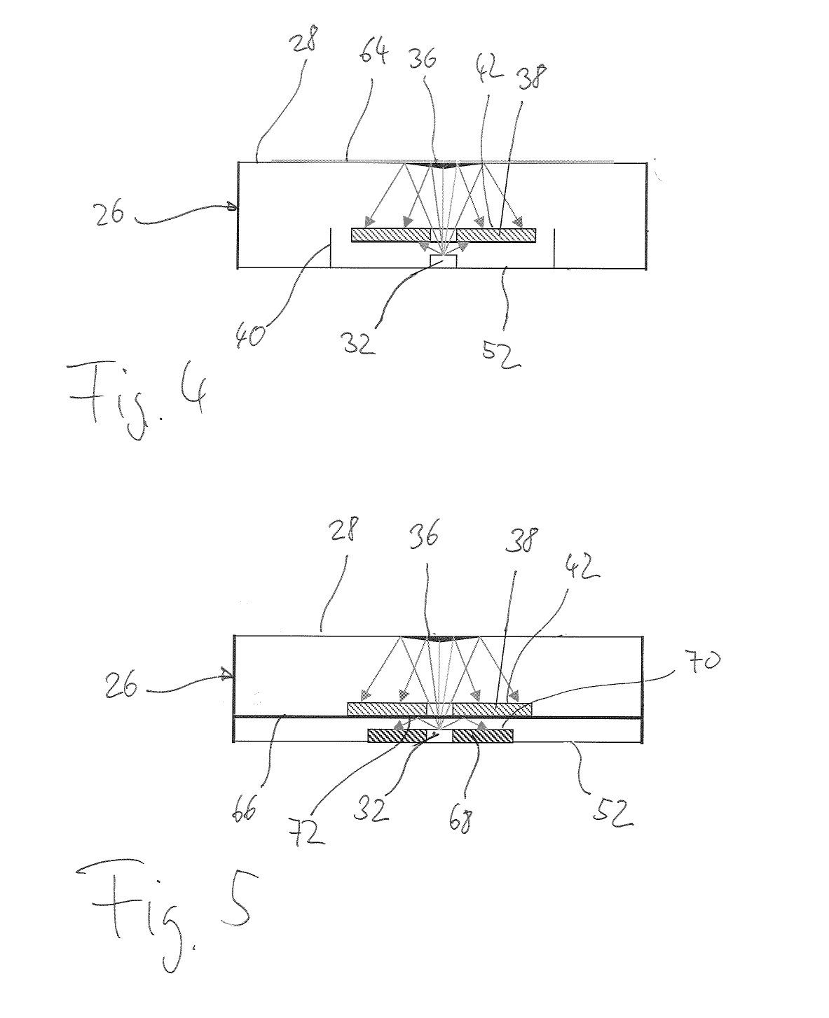

In the embodiment of FIG. 4 the light source 32 and the detector 38 are supported by a reference membrane 52 which is opposite and parallel to the sensor membrane 28. The reference membrane 52 is arranged to seal a further opening of the housing 26 and is exposed to surrounding soft tissue. The sensor membrane 28 is provided with a compensation mass 64 for compensating the mass loading on the reference membrane 52 due to the light source 32 and the detector 38. Preferably, the sensor membrane 28 and the reference membrane 52 are balanced in terms of internal damping and spring constant.

A modification of the embodiment of FIG. 4 is shown in FIG. 5, wherein the detector 38 is supported by a rigid part of the housing 26, namely by an intermediate wall 66 extending across the housing parallel to the sensor membrane 28, while the light source 32, as in the embodiment of FIG. 4, is supported by a reference membrane 52 sealing a further opening of the housing 26 and being exposed to soft tissue. The reference membrane 52 in addition supports an auxiliary light detector 68 which outputs a signal corresponding to the total light intensity impinging onto the light-sensitive surface 70 of the auxiliary detector 68, with the intermediate wall 68 comprising an auxiliary reflector element 72 for reflecting light from the light source 32 onto the auxiliary detector surface 70. The auxiliary detector surface 70 is essentially parallel to the intermediate wall 68 and the senor membrane 28. The light source 32 is located in a central region of the auxiliary detector 68. Thereby the reflected light impinges at an oblique angle onto the auxiliary detector surface 70, so that the total light intensity falling onto the auxiliary detector surface 70 varies as a function of the position of the auxiliary reflector element 72 relative to the auxiliary light detector surface 70. Consequently, when the central region of the reference membrane 52 is deflected in the direction 44 towards or away from the intermediate wall 66, the output signal of the auxiliary light detector will vary accordingly. By combining the output signals of the (main) detector 38 and the output signal of the auxiliary detector 68 in an appropriate manner, signals caused by acceleration of the microphone 20 and the soft tissue surrounding the microphone 20 can be separated from signals caused by sound waves in the soft tissue, so that detector output signal components resulting from acceleration forces acting on the microphone 20 can be eliminated.

The approach to reduce signals resulting from acceleration forces in the embodiments of FIGS. 3 to 5 is based on the consideration that acceleration forces are expected to act similarly on the sensor membrane 28 and the reference membrane 52.

Since the acceleration forces result in parallel movement of the sensor membrane 28 and the reference membrane 52, in the embodiments of FIGS. 3 and 4 the effect of acceleration forces on the distance between the sensor membrane (which is provided with the reflector element 36) and the reference membrane 52 (which supports the detector 38) is reduced, thereby reducing the effect of acceleration forces on the output signal of the detector 38.

By contrast, in the embodiment of FIG. 5 the displacement of the reference membrane 52 is measured by the auxiliary detector 68, so that the output signal of the auxiliary detector 52 can be used, by combining it with the signal of the (main) detector 38 in an appropriate manner, to eliminate signal components due to acceleration forces in the combined signal.

The reference membrane 52 in the embodiments of FIGS. 4 and 5 also responds to sound waves: while acceleration forces act in similar manner on both the sensor membrane 28 and on the reference membrane 52 (thereby creating similar output signals of the main detector 38 and the auxiliary detector 52 of FIG. 5), sound waves in the soft tissue resulting from ambient sound are expected to act on the sensor membrane 28 and on the reference membrane 52 essentially in opposite directions (since the wavelength of sound waves in tissue is larger than the typical microphone dimensions, the tissue pressure created by a sound wave traveling through the tissue is experienced by the microphone 20 as a periodically rising and falling pressure which is more or less constant over the entire outer surface of the microphone 20, i.e. both membranes 28 and 52 experience essentially the same pressure). Thus, by considering in the embodiment of FIG. 5 the output signals of both detectors 38, 52, signals caused by acceleration of the sensor arrangement (and the tissue above/below the sensor arrangement) can be distinguished and separated from signals resulting from sound waves traveling through the tissue around the sensor arrangement. In the embodiment of FIG. 4, the response of the reference membrane 52 to sound waves enhances the response of the distance between the sensor membrane 28 and the detector 38 to sound waves, thereby improving the signal to noise ratio of the microphone signal.

Further, since the microphone 20 is to be placed in soft tissue, signals resulting from transmission of bone conduction sound are substantially eliminated.

Typically, the sensor membranes 28 and the auxiliary membranes 52 are of circular shape, and the housing 26 has a circular cylindrical shape.

1. An implantable microphone, comprising:
a source of incoherent light,
a light detector for outputting a signal corresponding to a total light intensity of the incoherent light and impinging onto a detector surface,
a housing for housing the light source and the detector, and
a sensor membrane for being exposed to surrounding soft tissue, the membrane being arranged to seal an opening of the housing and comprising reflector means provided at the inner side of the sensor membrane for reflecting light from the light source onto the detector in manner that the total light intensity reflected onto the detector varies as a function of the position of the reflector means relative to the detector.

2. The microphone of claim 1, wherein at least part of the reflected light impinges at an oblique angle onto detector surface.

3. The microphone of claim 2, wherein at the detector surface is essentially parallel to the sensor membrane.

4. The microphone of claim 1, wherein the reflector means is a reflector element provided in a central region of the sensor membrane.

5. The microphone of claim 4, wherein the reflector element comprises at least one light reflecting surface which is angled with regard to the sensor membrane.

6. The microphone of claim 4, wherein the reflector element has a convex shape.

7. The microphone of claim 4, wherein the reflector element is symmetric with regard to a central point.

8. The microphone of claim 7, wherein the reflector element has a spherical, cone-like, pyramid-like or truncated shape.

9. The microphone of claim 1, wherein the detector is arranged between the light source and the sensor membrane, and wherein the detector is provided with an opening acting as an aperture for allowing light from the light source to pass through the opening to the reflector means.

10. The microphone of claim 1, wherein the interior of the housing is blackened in order to reduce stray light.

11. The microphone of claim 1, wherein a backside of the detector blackened in order to reduce stray light.

12. The microphone of claim 1, wherein the detector is a photodiode.

13. The microphone of claim 1, wherein the light source is a SLED.

14. The microphone of claim 1, wherein the microphone is for placement in soft tissue.

15. The microphone of claim 1, wherein the light source and the detector are rigidly supported by a stiff wall of the housing opposite to the sensor membrane.

16. The microphone of claim 1, wherein at least one of the light source and the detector is elastically supported by the housing in a manner that the light source and the detector, respectively, is displaceable in a direction towards and away from the sensor membrane.

17. The microphone of claim 16, wherein the light source and the detector are elastically supported by the housing via a support arrangement at a position opposite to the sensor membrane in a manner that the light source and the detector are displaceable in a direction towards and away from the sensor membrane, with the support arrangement being fixed at a rigid part of the housing.

18. The microphone of claim 17, wherein the support arrangement is designed such that a damping and a spring constant of the support arrangement are adjustable.

19. The microphone of claim 17, wherein the support arrangement comprises a reference membrane fixed at and extending across the housing parallel to the sensor membrane, and wherein the light source and the detector are supported by the reference membrane.

20. The microphone of claim 19, wherein the housing contains means for adjusting the pressures within a first internal cavity of the housing and a second internal cavity of the housing separated from the first internal cavity of the housing by the reference membrane in order to adjust a spring constant of the support arrangement.

21. The microphone of claim 17, wherein the support arrangement comprises an active magnetic damping element acting as support for a central region of the reference membrane.

22. The microphone of claim 21, wherein the magnetic damping element comprises a coil fixed at a stiff wall of the housing opposite to the sensor membrane and a magnetic core located in the coil and supporting the central region of the reference membrane.

23. The microphone of claim 22, further comprising means for applying a current to the coil in order to adjust at least one of a spring constant and a damping of the support arrangement.

24. The microphone of claim 23, wherein said current applying means are for applying a DC current to the coil in order to adjust the spring constant of the support arrangement.

25. The microphone of claim 16, wherein the light source and the detector are supported by a reference membrane opposite and parallel to the sensor membrane.

26. The microphone of claim 25, wherein the sensor membrane is provided with a compensation mass for compensating the mass loading of the light source and the detector on the reference membrane.

27. The microphone of claim 26, wherein the sensor membrane and the reference membrane are balanced in terms of internal damping and spring constant.

28. The microphone of claim 16, wherein the detector is supported by a rigid part of the housing, and wherein the light source is supported by a reference membrane extending opposite and parallel to the sensor membrane.

29. The microphone of claim 28, wherein the detector is supported by an intermediate wall of the housing extending across the housing parallel to the sensor membrane.

30. The microphone of claim 29, further comprising an auxiliary light detector supported by the reference membrane, wherein the auxiliary light detector is for outputting a signal corresponding to the total light intensity impinging onto the auxiliary light detector surface, wherein the intermediate wall comprises auxiliary reflector means for reflecting light from the light source onto the auxiliary light detector surface in manner that the total light intensity reflected onto the auxiliary light detector surface varies as a function of the position of the auxiliary reflector relative to the auxiliary light detector, and wherein the microphone further comprises means for combining the output signal of the light detector and the output signal of the auxiliary light detector in a manner so as to eliminate signals resulting from acceleration forces acting on the microphone.

31. The microphone of claim 1, wherein the reference membrane is for being exposed to surrounding soft tissue and is arranged to seal a further opening of the housing.

32. A fully implantable hearing instrument comprising:
a microphone
a source of incoherent light,
a light detector for outputting a signal corresponding to a total light intensity of the incoherent light and impinging onto a detector surface,
a housing for housing the light source and the detector, and
a sensor membrane for being exposed to surrounding soft tissue, the membrane being arranged to seal an opening of the housing and comprising reflector means provided at the inner side of the sensor membrane for reflecting light from the light source onto the detector in manner that the total light intensity reflected onto the detector varies as a function of the position of the reflector means relative to the detector; and
an audio signal processing unit for further processing the output signals of the microphone and an output transducer for stimulating a patient's hearing according to the further processed signals.

33. A method of providing hearing assistance to a user, comprising
emitting incoherent light from a light source of an implantable microphone,
reflecting incoherent light from the light source at reflector means provided at the inner side of a sensor membrane of the microphone exposed to surrounding soft tissue,
detecting a total intensity of the light reflected at the reflector means onto a surface of a light detector of the microphone,
providing an output signal corresponding to the total intensity of the light reflected onto the detector surface, and
stimulating the user's hearing, by an implanted output transducer, according to the output signal,
wherein the sensor membrane is arranged to seal an opening of a housing of the microphone and wherein the light is reflected onto the detector surface in such a manner that the total light intensity reflected onto the detector surface varies as a function of the position of the reflector means relative to the detector.
